(19) United States
(12) Patent Application Publication
(10) Pub. No.: US 2015/0224752 A1
(43) Pub. Date: Aug. 13, 2015

(54) LAMINATE AND SURFACE PROTECTION PLATE

(71) Applicant: KIMOTO CO., LTD., Saitama-shi, Saitama (JP)

(72) Inventors: Sho Suzuki, Saitama-shi (JP); Nobuyoshi Fukui, Saitama-shi (JP); Satoshi Negishi, Saitama-shi (JP)

(73) Assignee: KIMOTO CO., LTD., Saitama-shi, Saitama (JP)

(21) Appl. No.: 14/422,982

(22) PCT Filed: Aug. 29, 2013
(86) PCT No.: PCT/JP2013/073203

§ 371 Date: Feb. 20, 2015

(30) Foreign Application Priority Data
Sep. 4, 2012 (JP) 2012-193903

(51) Int. Cl. B32B 27/40; B32B 27/08

(52) U.S. Cl. CPC B32B 27/40; B32B 27/08; B32B 2307/40; B32B 2457/20

(57) ABSTRACT

A laminated plate according to the present invention includes two or more resin films laminated via an adhesive layer, and at least one layer of the adhesive layer contains a resin component containing a polyol resin and an isocyanate curing agent, and a hydroxyl group-containing benzophenone compound, and the hydroxyl group-containing benzophenone compound is 55 parts by weight or less relative to 100 parts by weight of the resin component. The laminated plate has an ultraviolet absorption property, while it does not have a layer containing an ultraviolet absorbing agent on a surface. Therefore, it can be provided with a desired functional layer as needed. The laminate plate is suitably used as a protection plate for a display device.

### TECHNICAL FIELD

The present invention relates to a laminated plate including two or more resin films laminated via an adhesive layer, and particularly to a laminated plate having an ultraviolet shielding effect and including two resin films being strongly adhered to each other.

### BACKGROUND ART

In a display portion of an electronic device such as a PC monitor, television, and mobile phone, a surface protection plate made of a resin plate, such as an acrylic plate or a polycarbonate plate, or a glass plate is disposed. While the original function of the surface protection plate is to protect members or components inside the display portion from external shock, the surface protection plate is also required to be thin and lightweight, and have favorable processability in producing the surface protection plate by cutting processing. In order to address such needs, there has been proposed a laminated plate including two or more plastic films affixed to each other using an adhesive layer made of curable resin (Patent Document 1).

When the material of the surface protection plate is resin, the plate is also required to fill the role of protecting itself from ultraviolet rays of the sun or the like. Conventional techniques for protecting the resin plate from ultraviolet rays include attaching a film containing an ultraviolet absorbing agent and metal oxide (Patent Document 2), and providing a layer containing an ultraviolet absorbing agent and the like.

### CITATION LIST

### Patent Literatures

### Patent Document 1: JP-A-2009-126134 (Claims)

Patent Document 2: JP-A-2009-263474 (claim 1)

### SUMMARY OF THE INVENTION

### Problems to be Solved by the Invention

The surface protection plate is required to be highly functional in addition to the original function. For this purpose, the surface protection plate may be provided with a layer that provides a function (functional layer). Specific examples of the required functions include shatter resistance, scratch resistance, and stain resistance, and, with regard to an inner surface, printability for printing ink, adhesive property when affixed to another member or the like, and antireflection or low reflection properties. These functions are provided by laminating a specific functional layer, such as a hard coat layer, on the surface of the surface protection plate, for example.

However, as described above, when the resin layer containing an ultraviolet absorbing agent and the like is disposed on the surface of the surface protection plate to protect the surface protection plate from ultraviolet rays, the provision of the functional layer, such as a hard coat layer, on the surface of the surface protection plate may be hindered. In particular, many of the hard coat layers are made of an ionizing radiation curable resin that is cured by ultraviolet rays and the like. Thus, when a constituent component has an ultraviolet absorption capability, the adjustment of the ultraviolet ray absorption capability may be difficult and the hard coat capability may be lowered. Accordingly, it is difficult to provide a layer that doubles as the hard coat layer and the ultraviolet absorption layer.

Thus, an object of the present invention is to provide a laminated plate that can be provided with a functional layer on the surface as needed, and that has an ultraviolet absorption capability.

### Solution to the Problems

In a laminated plate according to the present invention, which solves the above problems, two or more resin films are adhered via an adhesive layer that doubles as an ultraviolet absorption layer. When the adhesive layer has an ultraviolet absorption capability, the adhesive property may be lowered depending on the combination or ratio of the adhesive component and the ultraviolet absorbing agent, or the transparency may be lowered by bleeding of the ultraviolet absorbing agent. As a result, suitability for a surface protection plate or the like may be impaired.

The present inventors have found that the ultraviolet absorption capability can be sufficiently provided and the adhesive property between the adhesive layer and the resin film can be increased by a combination of a specific ultraviolet absorbing agent and a specific resin component, and thereby arrived at the present invention.

Specifically, a laminated plate according to the present invention includes two or more resin films laminated via an adhesive layer, and is characterized in that at least one layer of the adhesive layer contains a resin component containing a polyol resin and an isocyanate curing agent, and a hydroxyl group-containing benzophenone compound, and that the content of the hydroxyl group-containing benzophenone compound is 55 parts by weight or less relative to 100 parts by weight of the resin component.

### Effects of the Invention

According to the present invention, the adhesive layer doubles as an ultraviolet absorption layer, so that a functional layer can be provided on a surface of the laminated plate as needed. Further, the adhesive property between the adhesive layer and the resin film in the laminated plate can be improved by the combination of the specific ultraviolet absorbing agent and the specific resin component.

### DESCRIPTION OF EMBODIMENTS

A laminated plate according to the present invention includes two or more resin films laminated via an adhesive layer, and is characterized in that at least one layer of the adhesive layer contains a resin component containing a polyol resin and an isocyanate curing agent, and a hydroxyl group-containing benzophenone compound, and that the hydroxyl group-containing benzophenone compound is 55 parts by weight or less relative to 100 parts by weight of the resin component.

Examples of the resin film used for the laminated plate according to the present invention include polyester films such as polyethylene terephthalate, polybutylene terephthalate, and polyethylene naphthalate, and various transparent plastic films made of polyethylene, polypropylene, triacetyl cellulose, polyvinyl chloride, polycarbonate, or the like.

The two or more resin films may be resin films of the same type or resin films of different types. Preferably, when resin films of different types are used, at least one biaxially-drawn polyethylene terephthalate film may be disposed on the outer-most surface for facilitating the shatter preventing capability. The same film may be disposed on both sides for easily preventing the warping. The surface of the plastic film may be treated with easy adhesion treatment such as corona discharge treatment or undercoating easy adhesion treatment.

The thickness of each resin film is not particularly limited, but the thickness of a single film is preferably 10 μm or more and more preferably 20 μm or more. The upper limit is preferably 300 μm or less and more preferably 200 μm or less. When the thickness is 10 μm or more, it is easy to suppress wrinkles, fracturing, or the like during the manufacture of the laminated plate. When the thickness is 300 μm or less, favorable processibility of the laminated plate, such as during cutting, is obtained.

The number of the laminated resin films differs depending on the thickness of a target laminated body or the thickness of constituent resin films, but is selected in accordance with processibility, the type of the functional layer to be provided, or the like. For example, when the target laminated body is on the order of 500 μm, the number of the adhesive layers can be increased by producing the laminated body using resin films on the order of several tens of μm rather than using resin films on the order of a hundred and several tens of μm. Since the respective layers can be provided with different functions, higher functionality can be provided. When the number of the laminated resin films is small, functions may be more easily added to the front and back of the laminated plate and to the adhesive layer, whereby the manufacturing steps can be simplified and the cost reduction can be achieved. The number of the steps is also reduced, whereby the influence of step-to-step error is advantageously decreased.

At least one layer of the adhesive layer contains a resin component containing a polyol resin and an isocyanate curing agent, and a hydroxyl group-containing benzophenone compound.

Examples of the polyol resin constituting the resin component include acrylic polyol resin, polyester polyol resin, alkyd resin, epoxy polyol resin, etc. When a polyester-based film is used as the resin film, it is preferable to use polyester polyol resin from the viewpoint of excellent adhesive property.

The hydroxyl value of the polyol resin may be 20 or less, preferably 10 or less, more preferably 8 or less, and particularly preferably 7 to 4. The hydroxyl value in this range contributes to a reaction with a later-described isocyanate curing agent, so that cohesion is easily increased.

The glass transition temperature of the polyol resin may be 20° C. or less, more preferably 10° C. or less, and even more preferably 5° C. or less. When the glass transition temperature is 20° C. or less, tackiness is easily generated, thereby facilitating the affixing. When the glass transition temperature is −20° C. or more, the strength after production is easily obtained.

The isocyanate curing agent also constituting the resin component may include tolylenediisocyanate, diphenylmethane diisocyanate, xylylene diisocyanate, isophorone diisocyanate, hexamethylene diisocyanate curing agents, etc., depending on the raw material isocyanate. Particularly, it is preferable to use a xylylene diisocyanate, isophorone diisocyanate, or hexamethylene diisocyanate curing agent from the viewpoint of non-yellowing property and weather resistance.

The isocyanate curing agent serves as a curing agent through a cross-linking reaction (formation of urethane bond) with the aforementioned polyol resin. The isocyanate curing agent is preferably ½ to 3 equivalents, particularly preferably 1 to 3 equivalents, relative to the polyol resin.

The hydroxyl group-containing benzophenone compound contains a benzophenone benzene ring to which one or more hydroxyl groups are bonded. The benzophenone compound is a substance that functions as an ultraviolet absorbing agent. In particular, by using a benzophenone compound to which a hydroxyl group is bonded, the adhesive property with the resin film can be increased when combined with the above-described resin component of the adhesive agent, in addition to providing the function as the ultraviolet absorbing agent.

Examples of the hydroxyl group-containing benzophenone compound include hydroxybenzophenone compounds such as 2-hydroxybenzophenone and 4-hydroxybenzophenone, dihydroxybenzophenone compounds such as 2,2′-dihydroxybenzophenone and 2,4-dihydroxybenzophenone, trihydroxybenzophenone compounds such as 2,3,4-trihydroxybenzophenone and 2,3,4′-trihydroxybenzophenone, and tetrahydroxybenzophenone compounds such as 2,2′,4,4′-tetrahydroxybenzophenone. The above-described benzophenone compounds include those to which other groups are attached. For example, a methyl group, an octyl group, or an ethylamide group may be attached.

Of these compounds, the greater the number of the hydroxyl groups, the more preferable it is. Specifically, the number of the hydroxyl groups is preferably two or more, more preferably 3 or more, and even more preferably 4 or more. As the number of the hydroxyl groups in the molecule is increased, the compatibility with the resin component and the solubility for the adhesive layer are improved.

It is considered that, in such hydroxyl group-containing benzophenone compound, the adhesive property with the resin film is improved by the reaction with the isocyanate curing agent in the resin component.

The hydroxyl group-containing benzophenone compound partly reacts with the isocyanate curing agent, and unreacted compounds can easily maintain compatibility with the resin component. Thus, bleed-out from the adhesive layer can be suppressed. Accordingly, even when the addition ratio of the hydroxyl group-containing benzophenone compound is increased so as to increase the ultraviolet absorption rate, a decrease in adhesive property and transparency due to bleed-out can be prevented.

The content of the hydroxyl group-containing benzophenone compound relative to 100 parts by weight of the resin component is preferably 55 parts by weight or less, more preferably 50 parts by weight or less, even more preferably 40 parts by weight or less, and particularly preferably 20 parts by weight or less. When the content is 55 parts by weight or less, favorable adhesive property by the resin component can be maintained. Further, whitening of the coating film due to bleed-out of the benzophenone compound from within the coating film can be prevented. The adhesive property is improved when even a small amount of the hydroxyl group-containing benzophenone compound is contained as compared with when not contained. However, in order to reliably increase the adhesive property and obtain the ultraviolet absorption property, the lower limit of the content is preferably 1 part by weight or more, more preferably 5 parts by weight or more, and even more preferably 10 parts by weight or more.

In order to minimize a change in shade of the laminated body and to maintain high transparency, the hydroxyl group-containing benzophenone compound is preferably 0.006 g or more, more preferably 0.012 g or more, and even more preferably 0.018 g or more, per 1 m² of the laminated body.

In addition to the above components, another resin component or additives such as a surface modifier, a leveling agent, an antioxidizing agent, or a hue regulator may be added to the adhesive layer.

However, the proportion of the total of polyol resin and the isocyanate curing agent in the resin component is preferably 80% or more and more preferably 90% or more. Thus, the adhesive property improving effect when used together with the above benzophenone compound can be maintained.

The thickness of the adhesive layer is preferably 1 to 50 μm. The lower limit of the thickness of the adhesive layer is more preferably 2 μm or more, even more preferably 5 μm or more, and particularly preferably 10 μm or more. The upper limit of the thickness is more preferably 40 μm or less and even more preferably 30 μm or less. When the thickness of the adhesive layer is 1 μm or more, the adhesive strength can be obtained. In particular, when the thickness is 5 μm or more, the area of air entrainment can be reduced in the event of entry of contaminants. When the thickness of the adhesive layer is 50 μm or less, the influence of flow of the adhesive layer before curing can be suppressed, and cohesive failure can be prevented. The development of unevenness due to convection during the drying of the adhesive layer can also be suppressed.

The physical properties of the laminated plate according to the present invention are determined by the materials and contents of the resin films and adhesive layer constituting the laminated plate as described above, and can be adjusted by adjusting the materials and contents. Preferable properties are as follows.

First, in terms of the ultraviolet absorption capability, the transmittance at wavelengths shorter than 385 nm is preferably 10% or less and more preferably 5% or less from the viewpoint of preventing degradation of the resin films and other members.

From the viewpoint of maintaining the color tone of the laminated body, it is preferable to decrease a color difference between a laminated plate provided by the addition of the hydroxyl group-containing benzophenone compound and a laminated plate provided without the addition. Specifically, ΔE*ab according to JIS K5600-4-6 is preferably 6.5 or less and more preferably 3.2 or less. From the viewpoint of ensuring transparency, the total light transmittance according to JIS K7361: 1997 is preferably 80% or more and more preferably 85% or more, and the haze according to JIS K7136: 2000 is preferably 1% or less and more preferably 0.5%.

In the laminated plate according to the present invention, the hydroxyl group-containing benzophenone compound included in the adhesive layer can readily maintain compatibility with the resin component in the adhesive layer. Thus, the total light transmittance and haze values can be in the above-described ranges.

Because of the above-described properties, the laminated plate according to the present invention can be suitably used as a cover panel of a touch-panel sensor or a liquid crystal module. The degradation of members of the touch-panel sensor or the liquid crystal module can be suppressed, and coloration can be reduced.

The laminated plate according to the present invention can be produced by applying a coating liquid containing the components constituting the adhesive layer and a solvent, which is added as needed, to the surface of a resin film to be laminated, overlaying another resin film, and curing the adhesive layer. When three or more resin films are laminated, the applying of the coating liquid for the adhesive layer and the curing of the adhesive layer may be successively performed. Alternatively, the coating liquid for the adhesive layer may be applied to each of two or more resin films, and the adhesive layer may be cured after a predetermined number of films are laminated. The curing of the adhesive layer may be performed using the heat for heating and drying the coating liquid for the adhesive layer, or by placing the adhesive layer stationary under a separate thermal environment.

The resultant laminated plate according to the present invention has greater strength than a single resin film layer of the same thickness as the laminated plate, and the adhesive property of the adhesive layer is increased. Thus, the resin films are not peeled off from the adhesive layer during processing or use.

The laminated plate according to the present invention may be suitably used as a surface protection plate for a display portion of electronic devices, and may also be used for general purposes of a resin plate or a glass plate. One surface or both surfaces may be provided with a functional layer as needed, such as a hard coat layer, an antireflection layer, a low reflection layer, a coloration layer, a printing ink adhesive layer, or an adhesive layer for affixing to another member. When functional layers are disposed on both surfaces of the laminated plate, the functional layers may have the same function or different functions.

### EXAMPLES

The present invention will be further described below with reference to Examples. The “parts” and “%” are based on weight unless otherwise mentioned.

### Example 1

On one surface of a polyester film (Cosmo Shine A4300: Toyobo Co., Ltd.) of 188 μm, the following adhesive layer paint was applied and dried, forming an adhesive layer with a thickness of 10 μm. Subsequently, onto the adhesive layer, a polyester film (Cosmo Shine A4300: Toyobo Co., Ltd.) of 188 μm was affixed, fabricating a laminated plate according to Example 1.

### <Adhesive Layer Paint>

| | | |
|---|---|---|
| Polyol-based polyester resin | 3.80 | parts by weight |
| (Vylon 500: Toyobo Co., Ltd., solid content | | |
| 100%) | | |
| Isocyanate curing agent | 0.64 | part by weight |
| (Takenate D-160N: Mitsui Chemicals, Inc., | | |
| solid content 75%) | | |
| Hydroxyl group-containing benzophenone | 0.76 | part by weight |
| compound | | |
| (Uvinul 3050: BASF Japan Ltd., solid | | |
| content 100%, the number of hydroxyl groups | | |
| in molecule 4) | | |
| Diluting solvent | 12.48 | parts by weight |

### Example 2

A laminated plate according to Example 2 was fabricated in the same manner as in Example 1 except that the adhesive layer paint of Example 1 was changed to the following adhesive layer paint.

### <Adhesive Layer Paint>

| | | |
|---|---|---|
| Polyol-based polyester resin | 4.30 | parts by weight |
| (Vylon 500: Toyobo Co., Ltd., solid content | | |
| 100%) | | |
| Isocyanate curing agent | 0.71 | part by weight |
| (Takenate D-160N: Mitsui Chemicals, Inc., | | |
| solid content 75%) | | |
| Hydroxyl group-containing benzophenone | 0.25 | part by weight |
| compound | | |
| (Uvinul 3050: BASF Japan Ltd., solid | | |
| content 100%, the number of hydroxyl groups | | |
| in molecule 4) | | |
| Diluting solvent | 12.16 | parts by weight |

### Example 3

A laminated plate according to Example 3 was fabricated in the same manner as in Example 1 except that the adhesive layer paint of Example 1 was changed to the following adhesive layer paint.

### <Adhesive Layer Paint>

| | | |
|---|---|---|
| Polyol-based polyester resin | 3.15 | parts by weight |
| (Vylon 500: Toyobo Co., Ltd., solid content | | |
| 100%) | | |
| Isocyanate curing agent | 0.53 | part by weight |
| (Takenate D-160N: Mitsui Chemicals, Inc., | | |
| solid content 75%) | | |
| Hydroxyl group-containing benzophenone | 1.52 | parts by weight |
| compound | | |
| (Uvinul 3050: BASF Japan Ltd., solid | | |
| content 100%, the number of hydroxyl groups | | |
| in molecule 4) | | |
| Diluting solvent | 12.96 | parts by weight |

### Example 4

A laminated plate according to Example 4 was fabricated in the same manner as in Example 1 except that the adhesive layer paint of Example 1 was changed to the following adhesive layer paint.

### <Adhesive Layer Paint>

| | | |
|---|---|---|
| Polyol-based polyester resin | 4.10 | parts by weight |
| (Vylon 500: Toyobo Co., Ltd., solid content | | |
| 100%) | | |
| Isocyanate curing agent | 0.68 | part by weight |
| (Takenate D-160N: Mitsui Chemicals, Inc., | | |
| solid content 75%) | | |
| Hydroxyl group-containing benzophenone | 0.51 | part by weight |
| compound | | |
| (Uvinul 3000: BASF Japan Ltd., solid | | |
| content 100%, the number of hydroxyl groups 2) | | |
| Diluting solvent | 12.32 | parts by weight |

### Example 5

A laminated plate according to Example 5 was fabricated in the same manner as in Example 1 except that the adhesive layer paint of Example 1 was changed to the following adhesive layer paint.

### <Adhesive Layer Paint>

| | | |
|---|---|---|
| Polyol acrylic resin | 11.32 | parts by weight |
| (Oribain BPS5296: Toyochem Co., Ltd., | | |
| solid content 35%) | | |
| Isocyanate curing agent | 0.06 | part by weight |
| (Oribain BXX4773: Toyochem Co., Ltd., | | |
| solid content 35%) | | |
| Hydroxyl group-containing benzophenone | 2.14 | parts by weight |
| compound | | |
| (Uvinul 3050: BASF Japan Ltd., solid | | |
| content 100%, the number of hydroxyl groups | | |
| in molecule 4) | | |
| Diluting solvent | 10.10 | parts by weight |

### Comparative Example 1

A laminated plate according to Comparative Example 1 was fabricated in the same manner as in Example 1 except that the adhesive layer paint of Example 1 was changed to the following adhesive layer paint.

### <Adhesive Layer Paint>

| | | |
|---|---|---|
| Polyol-based polyester resin | 2.30 | parts by weight |
| (Vylon 500: Toyobo Co., Ltd., solid content | | |
| 100%) | | |
| Isocyanate curing agent | 0.38 | part by weight |
| (Takenate D-160N: Mitsui Chemicals, Inc., | | |
| solid content 75%) | | |
| Hydroxyl group-containing benzophenone | 2.53 | parts by weight |
| compound | | |
| (Uvinul 3050: BASF Japan Ltd., solid | | |
| content 100%, the number of hydroxyl groups | | |
| in molecule 4) | | |
| Diluting solvent | 13.59 | parts by weight |

### Comparative Example 2

A laminated plate according to Comparative Example 2 was fabricated in the same manner as in Example 1 except that the adhesive layer paint of Example 1 was changed to the following adhesive layer paint.

### <Adhesive Layer Paint>

| | | |
|---|---|---|
| Acrylic resin | 8.70 | parts by weight |
| (Acrydic A-195: DIC Corporation, solid | | |
| content 50%) | | |
| Isocyanate curing agent | 0.72 | parts by weight |
| (Takenate D-110N: Mitsui Chemicals, Inc., | | |
| solid content 75%) | | |
| Hydroxyl group-containing benzophenone | 0.69 | part by weight |
| compound | | |
| (Uvinul 3050: BASF Japan Ltd., solid | | |
| content 100%, the number of hydroxyl groups | | |
| in molecule 4) | | |
| Diluting solvent | 8.44 | parts by weight |

### Comparative Example 3

A laminated plate according to Comparative Example 3 was fabricated in the same manner as in Example 1 except that the adhesive layer paint of Example 1 was changed to the following adhesive layer paint.

### <Adhesive Layer Paint>

| | | |
|---|---|---|
| Polyol-based polyester resin | 4.50 | parts by weight |
| (Vylon 500: Toyobo Co., Ltd., solid content | | |
| 100%) | | |
| Isocyanate curing agent | 0.75 | part by weight |
| (Takenate D-160N: Mitsui Chemicals, Inc., | | |
| solid content 75%) | | |
| Diluting solvent | 12.00 | parts by weight |

### Comparative Example 4

A laminated plate according to Comparative Example 4 was fabricated in the same manner as in Example 1 except that the adhesive layer paint of Example 1 was changed to the following adhesive layer paint.

### <Adhesive Layer Paint>

| | | |
|---|---|---|
| Polyol acrylic resin | 11.32 | parts by weight |
| (Oribain BPS5296: Toyochem Co., Ltd., | | |
| solid content 35%) | | |
| Isocyanate curing agent | 0.06 | part by weight |
| (Oribain BXX4773: Toyochem Co., Ltd., | | |
| solid content 35%) | | |
| Diluting solvent | 10.10 | parts by weight |

### T-Peel Strength

The laminated plates obtained according to Examples 1 to 5 and Comparative Examples 1 to 4 were peeled to the right and left at a peeling rate of 300 mm/min as in T-peel test to measure peeling strength. Those in which the base material was destroyed are expressed as “Excellent”, those in which no base material was destroyed but the force required for peeling was 10N/25 mm in width or more are expressed as “Good”, and those in which the force required for peeling was less than 10N/25 mm in width are expressed as “Poor”.

### Total Light Transmittance and Haze

The total light transmittance according to JIS K7361-1: 1997 and the haze according to JIS K7136: 2000 were measured for the laminated plates obtained according to Examples 1 to 5 and Comparative Examples 1 to 4 using a haze meter (NDH2000: Nippon Denshoku Industries Co., Ltd.). The results are shown in Table 1.

### Ultraviolet Transmittance

The light transmittance at wavelengths of 385 nm and 390 nm were measured for the laminated plates obtained according to Examples 1 to 5 and Comparative Examples 1 to 4 using a spectrophotometer (SolidSpec-3700: Shimadzu Corporation). The results are shown in Table 1.

### Color Difference

As to the color difference, a geometric distance (ΔE*ab) between two colors in the CIE 1976 (L*a*b*) color space was calculated according to JIS K5600-4-6. For Examples 1 to 4, the color difference from Comparative Example 3 was calculated. For Example 5, the color difference from Comparative Example 4 was calculated.

TABLE 1

| | | Total light | | Ultraviolet | Ultraviolet | Color |
|---|---|---|---|---|---|---|
| | T-peeling | transmittance | Haze | transmittance | transmittance | difference |
| | strength | (%) | (%) | [385 nm] (%) | [390 nm] (%) | (—) |
| Example 1 | Excellent | 90.7 | 2.6 | 0.2 | 0.8 | 1.7 |
| Example 2 | Excellent | 90.7 | 2.6 | 7.7 | 18.0 | 0.7 |
| Example 3 | Excellent | 90.2 | 4.3 | 0.8 | 0.7 | 3.9 |
| Example 4 | Excellent | 90.7 | 2.6 | 58.0 | 67.0 | 0.2 |
| Example 5 | Good | 90.1 | 6.0 | 0.8 | 0.7 | 1.7 |
| Comparative | Poor | 82.0 | 8.0 | 0.3 | 1.5 | 4.0 |
| Example 1 | | | | | | |
| Comparative | Poor | 82.0 | 8.0 | 0.3 | 1.5 | 1.6 |
| Example 2 | | | | | | |
| Comparative | Good | 90.7 | 2.6 | 85.0 | 86.0 | 0.0 |
| Example 3 | | | | | | |
| Comparative | Poor | 90.6 | 3.4 | 85.0 | 86.0 | 0.0 |
| Example 4 | | | | | | |

In the laminated plates of Examples 1 to 4, the adhesive layer contained the resin component containing a polyol-based ester resin and an isocyanate curing agent, and a hydroxyl group-containing benzophenone compound. The content of the hydroxyl group-containing benzophenone compound was 55 parts by weight or less relative to 100 parts by weight of the resin component. While the laminated plates of these Examples similarly contained the polyol ester resin and the isocyanate curing agent, the adhesive property between the adhesive layer and the resin film was improved as compared to Comparative Example 3, the laminated plate of which that did not contain the hydroxyl group-containing benzophenone compound.

In particular, from the laminated plates of Examples 1 to 3 in which the benzophenone compound with the number of hydroxyl groups of 4 was used, excellent results were obtained both in terms of adhesive property and ultraviolet absorption property. Among these plates, excellent results were obtained from the laminated plate of Example 1, in which the content of the hydroxyl group-containing benzophenone compound was 10 parts by weight or more and 20 parts by weight or less relative to 100 parts by weight of the resin component, in terms of all of adhesive property, ultraviolet absorption property, total light transmittance, haze, and color difference.

In the laminated plate of Example 5, the adhesive layer contained a resin component containing a polyol acrylic resin and an isocyanate curing agent, and a hydroxyl group-containing benzophenone compound. The content of the hydroxyl group-containing benzophenone compound was 50 parts by weight or less relative to 100 parts by weight of the resin component. The laminated plate of Example 5 was inferior, in terms of adhesive property, to the laminated plate of Examples 1 to 4 using a polyester resin. However, it can be seen that the adhesive property between the adhesive layer and the resin film was improved as compared to Comparative Example 4, the laminated plate of which contained a polyol acrylic resin and an isocyanate curing agent as in Example 5 but that did not contain a hydroxyl group-containing benzophenone compound.

Meanwhile, in the laminated plate of Comparative Example 1, the ratio of the adhesive component in the adhesive layer was decreased because a large amount of the hydroxyl group-containing benzophenone compound was contained in the adhesive layer. As a result, the laminated plate of Comparative Example 1 was inferior in adhesive property as compared to Examples 1 to 5, and the resin film was peeled off.

In the laminated plate of Comparative Example 2, an acrylic resin was used as the resin component of the adhesive layer. Since a polyol component was not contained in the adhesive layer, the laminated plate was inferior in adhesive property as compared to Examples 1 to 5, and the resin film was peeled off.

The laminated plates of Comparative Examples 1 and 2 did not have the adhesive strength between the adhesive layer and the resin film, and air was contained in some parts between the adhesive layer and the resin film. As a result, these laminated plates were inferior in total light transmittance and haze, as compared to the Examples.

1. A laminated plate comprising two or more resin films laminated via an adhesive layer, wherein
at least one layer of the adhesive layer contains a resin component containing a polyol resin and an isocyanate curing agent, and a hydroxyl group-containing benzophenone compound, and
the content of the hydroxyl group-containing benzophenone compound is 55 parts by weight or less relative to 100 parts by weight of the resin component.

2. The laminated plate according to claim 1, wherein the adhesive layer contains 5 parts by weight or more and 50 parts by weight or less of the hydroxyl group-containing benzophenone compound relative to 100 parts by weight of the resin component.

3. The laminated plate according to claim 1, wherein the hydroxyl group-containing benzophenone compound includes two or more hydroxyl groups.

4. The laminated plate according to claim 1, wherein the polyol resin is a polyol ester resin.

5. The laminated plate according to claim 1, wherein 0.006 g or more of the hydroxyl group-containing benzophenone compound is contained per 1 m² of the laminated body.

6. The laminated plate according to claim 1, further comprising one or more functional layers disposed on a surface of the laminated plate, the functional layers being selected from a hard coat layer, an antireflection layer, a low reflection layer, a coloration layer, a printing ink adhesive layer, and an adhesive layer.

7. A surface protection plate comprising two or more resin films laminated via an adhesive layer, wherein
at least one layer of the adhesive layer contains a resin component containing a polyol resin and an isocyanate curing agent, and a hydroxyl group-containing benzophenone compound, and
the hydroxyl group-containing benzophenone compound is 55 parts by weight or less relative to 100 parts by weight of the resin component.

8. The laminated plate according to claim 2, wherein the hydroxyl group-containing benzophenone compound includes two or more hydroxyl groups.

9. The laminated plate according to claim 2, wherein the polyol resin is a polyol ester resin.

10. The laminated plate according to claim 2, wherein 0.006 g or more of the hydroxyl group-containing benzophenone compound is contained per 1 m² of the laminated body.

11. The laminated plate according to claim 2, further comprising one or more functional layers disposed on a surface of the laminated plate, the functional layers being selected from a hard coat layer, an antireflection layer, a low reflection layer, a coloration layer, a printing ink adhesive layer, and an adhesive layer.

12. The laminated plate according to claim 3, wherein the polyol resin is a polyol ester resin.

13. The laminated plate according to claim 3, wherein 0.006 g or more of the hydroxyl group-containing benzophenone compound is contained per 1 m² of the laminated body.

14. The laminated plate according to claim 3, further comprising one or more functional layers disposed on a surface of the laminated plate, the functional layers being selected from a hard coat layer, an antireflection layer, a low reflection layer, a coloration layer, a printing ink adhesive layer, and an adhesive layer.

15. The laminated plate according to claim 4, wherein 0.006 g or more of the hydroxyl group-containing benzophenone compound is contained per 1 m² of the laminated body.

16. The laminated plate according to claim 4, further comprising one or more functional layers disposed on a surface of the laminated plate, the functional layers being selected from a hard coat layer, an antireflection layer, a low reflection layer, a coloration layer, a printing ink adhesive layer, and an adhesive layer.

17. The laminated plate according to claim 5, further comprising one or more functional layers disposed on a surface of the laminated plate, the functional layers being selected from a hard coat layer, an antireflection layer, a low reflection layer, a coloration layer, a printing ink adhesive layer, and an adhesive layer.
